(19) United States
(12) Patent Application Publication
(10) Pub. No.: US 2006/0139317 A1
(43) Pub. Date: Jun. 29, 2006

(54) Virtual environment navigation device and system

(75) Inventors: Ming C. Leu, Rolla, MO (US); Krishna Reddy Nandanoor, Lexington, NY (US); Vishal N. Lokhande, Minneapolis, MN (US); Troy Stull, St. Peters, MO (US)

Correspondence Address: GREER, BURNS & CRAIN, 300 S WACKER DR, 25TH FLOOR, CHICAGO, IL, 60606, US

(73) Assignee: The Curators of the University of Missouri

(21) Appl. No.: 11/285,253

(22) Filed: Nov. 22, 2005

Related U.S. Application Data
(60) Provisional application No. 60/630,523, filed on Nov. 23, 2004.

(51) Int. Cl. G09G 5/00

(52) U.S. Cl. 345/156

(57) ABSTRACT

An impact platform device for use with a virtual reality interface system that promotes navigation by a user in a virtual environment, the platform device including a platform being configured to receive impacts from the user, an odd-numbered plurality of sensors evenly spaced about a circumference and disposed relative the platform such that each of the sensors is configured to detect when the user impacts a portion of the platform.

### PRIORITY CLAIM AND APPLICATION REFERENCE

Under 35 U.S.C. §119, this application claims the benefit under of prior provisional application Ser. No. 60/630,523, filed Nov. 23, 2004.

### FIELD OF THE INVENTION

A field of the invention is virtual reality. Another field of the invention is devices for interacting in a virtual reality environment.

### BACKGROUND OF THE INVENTION

Virtual reality has widespread applications in a variety of fields, and has proven especially useful in training and educational applications. For example, emergency personnel such as firefighters and emergency medical personnel may be trained using virtual reality techniques, which is also useful for a host of other non-emergency employment training as well. Training that uses virtual reality is especially advantageous because it is safe, reduces length of time required for training, consumes relatively little space, is cost effective, and permits a wide range of training scenarios that might not otherwise be available in the physical world. Training of emergency first responders, for instance, is very costly and cannot be carried out in civilian areas due to the fear of instigating panic. In such a case, virtual reality is invaluable and can be used to effectively create authentic training scenarios and to train first responders. Real life situations and events may be replication, and virtual reality systems can be adapted to numerous situations.

Virtual reality techniques have also found widespread use in interactive virtual navigation simulation technology to add mechanical control and dynamic computation to create a more realistic simulation environment for exercising and gaming. Gaming experiences are enhanced in virtual reality environments, for example, creating excitement.

Interactive virtual navigation devices permit a user to interact with a virtual reality environment. Currently, several types of interactive virtual navigation devices are available for training, exercising and gaming, such as joysticks, treadmills, and hexapods. Two desired features in virtual training or exercising are a user's abilities to navigate in a virtual world through physical assertions and to achieve real-time maneuvering, both of which are difficult to accomplish by existing devices in a cost-effective manner. Available and proposed devices that can provide omni-directional movement tend to be complex and expensive.

U.S. Pat. No. 6,743,154, for example, proposes an omni-directional moving surface used as a treadmill. The '154 patent states that the surface operates as treadmill designed to enable full 360-degree freedom of locomotion and can interact with a virtual reality environment. The device of the '154 patent includes a plurality of ball bearings; a bladder for enveloping the plurality of ball bearings; and an interface for connecting the bladder to a virtual reality processor. A spindle positions the ball bearings such that the ball bearings form a ring around the spindle. The spindle has a top portion to support the weight of a user; a base including a plurality of ball bearings for holding the bladder; a viscous substance enveloped by the bladder and in contact with the ball bearings; and a track ball contacting the bladder and serving as an interface between the bladder and a virtual reality processor

A Step-in-Place Turn-Table System has been designed by the Precision and Intelligence Lab at the Tokyo Institute of Technology. The system includes a turntable with embedded sensors that is used as the walking platform to compensate users' rotations. Compensations by the turntable can cause its user to lose sight of a display screen, which makes real-time navigation difficult to achieve, if not impossible.

A prototype device referred to as the “Pressure Mat”, was designed by the Southwest Research Institute, and intended to permit walking, running, and turning in a virtual environment to a limited degree. Pressure-sensitive resistors detect whether a user is standing, walking forward or backward, or sidestepping left or right. The pressure-sensitive resistors in the prototype Pressure Mat were arranged hexagonally to reduce directional bias, on a Lexan® sheet. Achieving accuracy in detecting movement with a reasonably sized interaction surface would require a large number of pressure-sensitive resistors sensors. A large number of sensor inputs increases computation intensity, prolongs processing time and makes real-time response/maneuvering difficult.

### SUMMARY OF THE INVENTION

Embodiments of the invention include an impact platform device for use with a virtual reality interface system that promotes navigation by a user in a virtual environment. The platform device includes a platform being configured to receive impacts from the user as well as an odd-numbered plurality of sensors evenly spaced about a circumference and disposed relative to the platform such that each of the sensors is configured to detect when the user impacts a portion of the platform.

Embodiments of the invention also include a software subsystem for use with a virtual reality navigation interface system using the platform device where the subsystem includes alignment instructions for alignment Xᵥ, Yᵥ and Zᵥ coordinate axes of the system with the user's coordinate axes Xᵤ, Yᵤ, Zᵤ. Orientation instructions are provided with the subsystem for detecting the user's orientation based on data received from the orientation device, prediction instructions are provided for predicting the user's navigation intention. Detection instructions are provided for detecting a number of impacts made by the user.

Still other embodiments include a method of determining user movement in a virtual reality interface system that promotes navigation by a user in a virtual environment that includes obtaining signals from an odd number of sensors disposed evenly about a circumference, designating a master sensor, and dividing with a diameter an area confined by the circumference into a first semicircle and a second semicircle. The first semicircle includes the master sensor, which is disposed within the first semicircle at an angle of 90 degrees with respect to the diameter, and one half of the remaining sensors. The other half of the sensors are disposed in the second semicircle.

### BRIEF DESCRIPTION OF THE DRAWINGS

FIG. 1 is a perspective view illustrating a virtual environment navigation pad (VENP) system in operation according to a preferred embodiment of the invention;

FIG. 2 is a block diagram illustrating a functional configuration of the VENP system illustrated in FIG. 1;

FIG. 3 is a front perspective exploded view of the preferred platform assembly of the VENP system illustrated in FIG. 1;

FIG. 4a is a top elevational view of a base of the platform assembly illustrated in FIG. 3;

FIG. 4b is a side elevational view of the base illustrated in FIG. 4a;

FIG. 4c is a top perspective view of the base illustrated in FIG. 4a;

FIG. 5a is a top elevational view of an impact platform of the platform assembly illustrated in FIG. 4a;

FIG. 5b is a side elevational view of the impact platform illustrated in FIG. 5a;

FIG. 6 is a front elevational view of the VENP system illustrated win FIG. 1 with a user disposed thereon;

FIG. 7 is a flow chart depicting the implementation of a software subsystem according to the preferred embodiment of the invention;

FIG. 8 is a side elevational view of the preferred VENP system; and

FIG. 9 is an exposed view of the unassembled platform assembly.

### DETAILED DESCRIPTION OF THE PREFERRED EMBODIMENTS

The invention provides an interactive virtual navigation device that can provide real-time navigation and direction control and simulate natural walking, running, and turning, with simple design and at a low cost. The invention provides Virtual Environment Navigation Pad (hereinafter, the “VENP”), which is virtual reality navigation interface device that promotes navigation by a user in a virtual environment. The device includes, generally, a platform assembly on which the user exerts impact, where the platform assembly includes a plurality of sensors for sensing the user's impacts. A typical impact would include the impact made by the user's steps during walking or running.

An embodiment of the invention is a virtual reality system that includes a VENP and additionally includes an orientation device coupled to the user to detect the user's orientation. Data regarding the user's impacts are communicated to a data acquisition (DAQ) interface, and the impact data is then communicated to a processor, such as PC or other processor, along with orientation data from the orientation device. The combined data is then synthesized to communicate with a virtual reality display device via a virtual reality engine.

The present invention also provides a computational method and corresponding software program (hereinafter, the “software subsystem”) for detecting a user's gestures and movements and enabling the user to achieve real-time navigation in a virtual environment. The method includes collecting orientation data (Pitch, Yaw and Roll angles) by the orientation device, transferring the orientation data to the processor, collecting the impact data (number of instances that the sensors go from “low” to “high”) by the plurality of sensors after the user takes steps on a platform assembly to initiate movement in a virtual environment, transferring the impact data to the processor via the DAQ interface, analyzing the impact data along with the orientation data, calculating the user's orientation and number of steps made and to determine the user's navigation intention (to go forward or backward) in the virtual environment, and providing the orientation changes and number of steps made to a virtual reality engine, a software program required to create a newly changed virtual environment.

Embodiments of the invention provide a low-cost navigation interface that facilitates navigation (walking, running, and turning) in a virtual environment. It simulates natural walking movement, provides good orientation control, and allows navigation in both forward and backward directions. Some particularly preferred embodiments will now be discussed with respect to the drawings. Artisans will understand the embodiments invention from the schematic drawings and logic flow diagrams, as well as broader aspects of the invention.

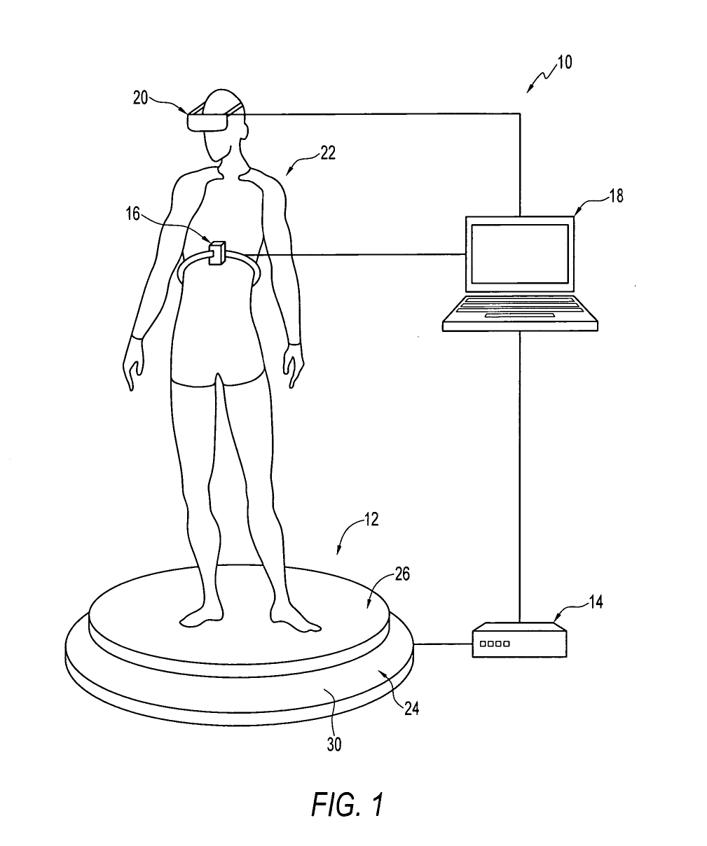

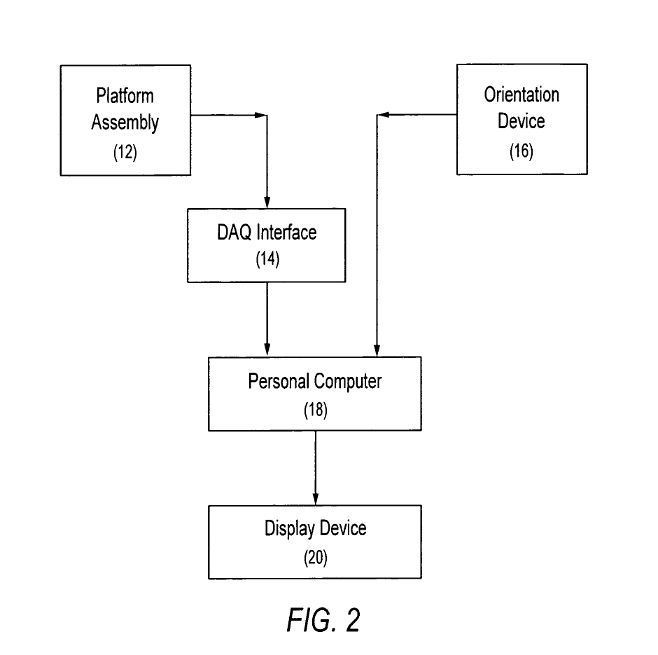

Turning now to FIGS. 1 and 2, a preferred virtual reality navigation system is designated generally at 10, and includes a platform assembly, generally at 12, a DAQ interface 14, an orientation device 16, a PC 18 or other processor, and a virtual reality display device 20. As illustrated in FIG. 2, the platform assembly 12, which receives input from a user, generally at 22, communicates that input with the DAQ interface 14, which in turn communicates data with the PC 18. Similarly, the orientation device 16, which is typically coupled to the user 22, communicates with the PC 18. The PC 18, which is installed with software subsystem according to an embodiment of the invention, as well as being equipped with a commercially available virtual reality engine, communicates data received from the orientation device 16 and the DAQ interface 14 to the display device 20. After the two sets of data obtained from the DAQ interface 14 and the orientation device 16 are analyzed using a novel algorithm of the invention, corresponding changes of the user's 22 position and orientation in the virtual environment are displayed in real-time through the display device 20.

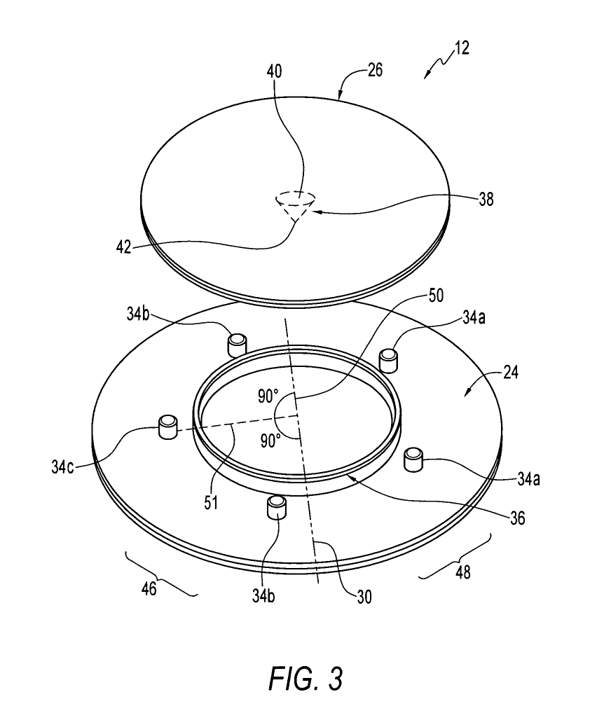

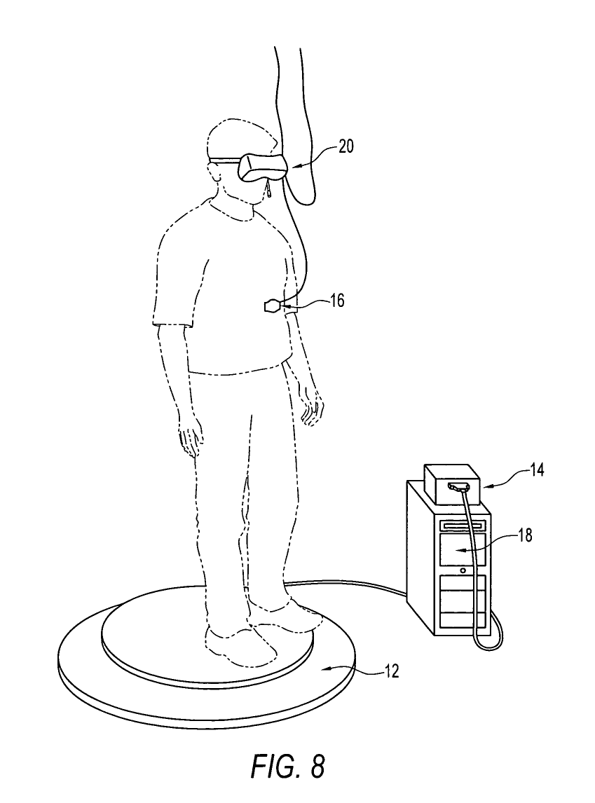

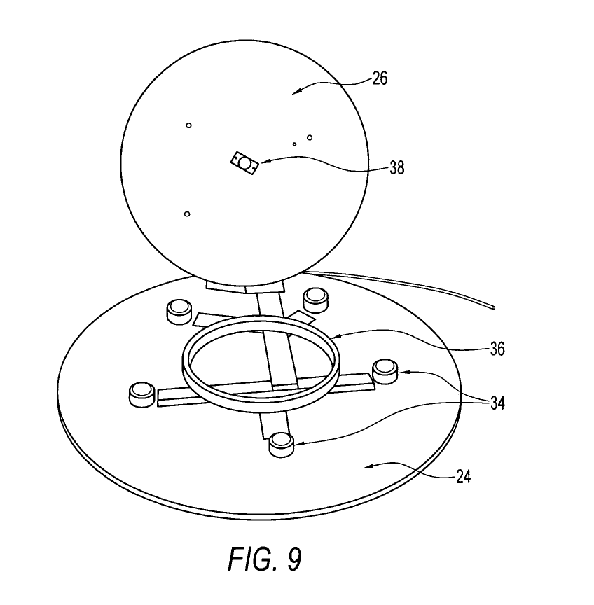

More particularly, turning to FIGS. 3, 4a-4c, 5a and 5b, the platform assembly 12 preferably includes a base, generally at 24, and an impact platform, generally at 26. While it is contemplated that the base 24 and impact platform 26 may assume a variety of sizes and configurations to suit individual applications, one preferred configuration is for both the base and impact platform to be generally flat and generally circular in shape, with an outer circumference of the base being equal to or larger than that of the impact platform. Both the base 24 and impact platform 26 may be composed of one of many rigid materials, including but not limited to wood, plastic, glass, and metal. In one exemplary embodiment, as illustrated in FIGS. 8 and 9, the base 24 is made of wood, is generally circular shape and has a diameter of approximately 50 inches. Similarly, one exemplary impact platform 26 is made of wood, is generally circular in shape with a diameter of approximately 30 inches.

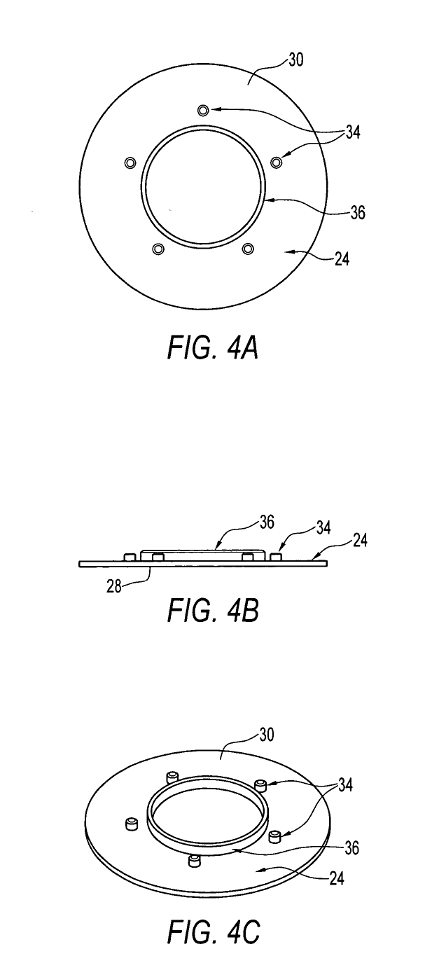

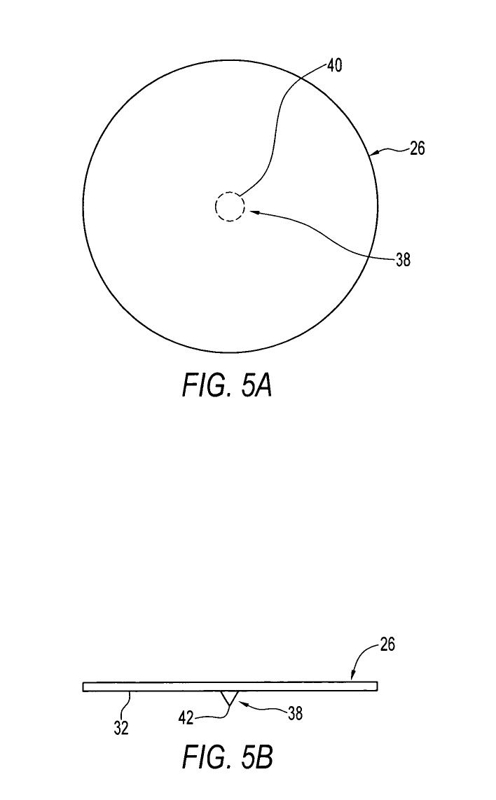

During operation of the VENP 10, the base 24 and impact platform 26 are preferably oriented such that the central axes of each of the base and impact platform are generally coextensive, with the base being positioned elevationally beneath the impact platform. A base underside 28 (best shown in FIGS. 4a-4c) is generally planar and configured to abut a floor or other surface, while a sensing surface 30 of the base opposite the underside is configured to abut a contact surface 32 (best shown in FIGS. 5a, 5b) disposed on an underside of the impact platform 26.

While it is contemplated that the sensing surface 30 may assume a variety of configurations to suit individual applications, one preferred configuration includes features to promote sensing of pressure exerted on the platform assembly 12, as well as features to promote cushioning and spring action. For example, as illustrated in FIG. 3, the sensing surface 30 may include a plurality of sensors 34a, 34b, 34c, for example five sensors, disposed radially thereon, where the sensors are generally spaced at regular intervals. The sensors detect the user's 22 stepping movement or other impact by varying between at least two positions, such as “low” and “high,” where by convention, “low” is the setting whereby no impact is perceived by the individual sensor 34a, 34b, 34c and “high” is the setting whereby impact is perceived. Different types of sensors are contemplated for use with the invention, including but not limited to, contact sensors, pressure sensors, strain gauges, force sensors, and optical sensors.

More particularly, embodiments of the invention contemplate various numbers of sensors 34, 34b, 34c, where the number provided is an odd number, with one of the sensors being designated the “master sensor.” For example, the preferred embodiment provides five sensors 34a, 34b, 34c, but the invention may be practiced with alternative odd numbers. The sensors 34a, 34b, 34c are preferably configured and arranged such that the sensors are evenly spaced about a circumference. In the preferred embodiment for example, where there are five sensors 34a, 34b, 34c, the sensors are each separated by approximately 72°. This is particularly advantageous in that by providing relatively few sensors 34a, 34b, 34c, there are few inputs for the virtual reality engine, thereby decreasing delay between updated of the virtual environment.

Additionally, the sensing surface 30 may include a cushioning member 36 for absorbing shocks and vibrations and producing spring action to break contact between the sensors 34a, 34b, 34c and the impact platform 26. While the invention contemplates a variety of configurations for the cushioning member 36, one preferred cushioning member is a pneumatic rubber ring disposed between a central axis of the base 24 and a circumference formed by the sensors 34a, 34b, 34c. The cushioning member 36 may include a variety of structures, such as springs, dampers, pneumatic tubes, and rubber pads, as well as other shock absorbing materials.

An engagement member, generally at 38, is also preferably provided to operably engage the impact platform 26 to the base 24. As illustrated in FIGS. 3 and 5, one preferred engagement member 38 is a generally conically shaped pivoting member having a generally planar base portion 40 configured to engage the generally planar contact surface 32 of the impact platform 26 while a point 42 is configured to abut the sensing surface 30 of the base 24. The engagement member 38 may be composed of any rigid material, including but not limited to, wood, plastic, glass, and metal. A height of the engagement member 38 is configured such that when the sensors 34a, 34b, 34c are inactive when no load (no impact) is applied to the platform assembly 12.

Thus, when the base 24 and impact platform 26 are engaged to one another, the sensors 34a, 34b, 34c are sandwiched between the base and the impact platform and in electronic communication with the DAQ interface 14. Once a user 22 applies a load to the platform assembly 12 by stepping or other impact, the sensors 34a, 34b, 34c collect the impact data (e.g., stepping data), which is the number of instances that the sensors 34a, 34b, 34c go from “low” to “high.”

The DAQ interface 14 is in electronic communication with the sensors 34a, 34b, 34c and the PC 18, and transfers the data collected by the sensors to the PC for further analysis and integration into the virtual environment. The DAQ interface 14 can be either hardware or software based. In the preferred embodiment the DAQ interface 14 is hardware based.

The orientation device 16 may be coupled to the user 22 via a number of mechanisms, such as by mounted or fitting on the user's body, and is in electronic communication with the PC 18. The orientation device 16 collects the 3-D orientation data, specifically pitch, yaw and roll angles, of the user 22. Most conventional orientation sensors or devices may be adopted in the instant VENP system 10, including but not limited to, inertial sensors, geo-magnetic sensors, infra-red sensors, and optical sensors. In one of the preferred embodiments, the inertial orientation device 16 is an inertial sensor mounted on a user's torso, as illustrated in FIG. 8.

The PC 18 employed in the VENP system 10 is installed with a virtual reality engine, which is a software program required by a PC to create a virtual environment. The PC is also equipped with the software subsystem of the invention. Exemplary commercially available virtual reality engines include but are not limited to the following: EON Reality®, manufactured by EON Reality, Inc. of Irvine, Calif.; Half-Life®, manufactured by Sierra Entertainment of Bellevue, Wash.; 3D Games Studio® manufactured by Conitec Datasystems, Inc. of San Diego, Calif.; Open Performer™ manufactured by SGI of Mountain View, Calif.; VR Juggler™ manufactured by Iowa State University in Ames, Iowa; and Quake® manufactured by id Software in Mesquite, Tex. One preferred embodiment includes the virtual reality engine Half-Life® Gaming Engine.

The display device 20 is in electronic communication with the PC 18. It is contemplated that most conventional and commercially available virtual reality display devices may be used in connection with the preferred VENP system 10. For example, suitable common display devices 20 include head mounted displays, CRT (cathode ray tube) monitors, video game consoles, and CAVE® (Computer automated virtual environment). In one of the preferred embodiments, a head-mounted display (HMD) gear is used as the display device 20, as illustrated in FIG. 8.

The preferred embodiment of the invention also includes a software subsystem and a method for determining the navigational parameters of the user 22, thereby enabling the user to achieve real-time navigation in a virtual environment.

The preferred method for determining navigational parameters generally includes 1) collecting orientation data from the user 22, preferably via the orientation device 16, 2) transferring orientation data to the PC 18 or other processor, 3) collecting impact data, such as stepping data, from the platform assembly 12, 4) transferring impact data to the PC 18, preferably via the DAQ interface 14, 5) analyzing both the impact data and orientation data using a preferred algorithm to make determinations about the user's 22 activity and 6) providing the determinations about the user's activity to the virtual reality engine, in response to which the virtual reality engine will update the virtual reality display of the display device 20.

More particularly, the step of collecting orientation data from the user 22 preferably entails communicating with the orientation device 16 and receiving data therefrom, such as pitch, yaw and roll angles of the user 22 as perceived by the orientation device that is coupled to the user. The orientation device 16 is in communication with the PC 18, and transfers the orientation data to the PC.

The impact data is collected from the platform assembly 12 after the user 22 has commenced impact activity on the platform assembly via the plurality of sensors 34a, 34b, 34c disposed on the sensing surface 30 of the base 24. Impact data may be one or more of several parameters, such as the number of steps taken by the user 22 and the direction of movement by the user. Impact data may also include jumping, tapping, running-in-place, swaying and kneeling, as well as other movements by the user 22 susceptible of being detected by sensors 34a, 34b, 34c. The impact data is transferred to the PC 18 via the DAQ interface 14.

The impact data is analyzed along with the orientation data using a preferred algorithm designed to detect the orientation of the user 22, the number of impacts (e.g., steps) made by the user, as well as to predict the user's navigation intention, such as whether the user intends to go forward or backward in the virtual environment. The orientation and impact data are transferred to a virtual reality engine, which will correspondingly update the virtual reality display with respect to changes in the user's 22 position and orientation. The steps of the invention are repeatedly processed at the graphics update rate. While the graphics update rate will vary based on the type of display device used 20, one exemplary range for the graphics update rate is from between 20 and 60 hertz.

The present invention provides a computational method as well as software subsystem in connection with the step of analyzing impact and orientation data to make determinations regarding the user's 22 position, activity and intentions.

More particularly, the computational method generally includes the steps of 1) aligning the directions of the VENP system 10 coordinate axes (Xᵥ, Yᵥ, Zᵥ) with a user's 22 coordinate axes (Xᵤ, Yᵤ, Zᵤ); 2) detecting an orientation of the user 22; 3) predicting the user's 22 navigation intention (e.g., to go forward or backward); and 4) detecting the number of impacts (e.g., walking/running steps) made by the user 22.

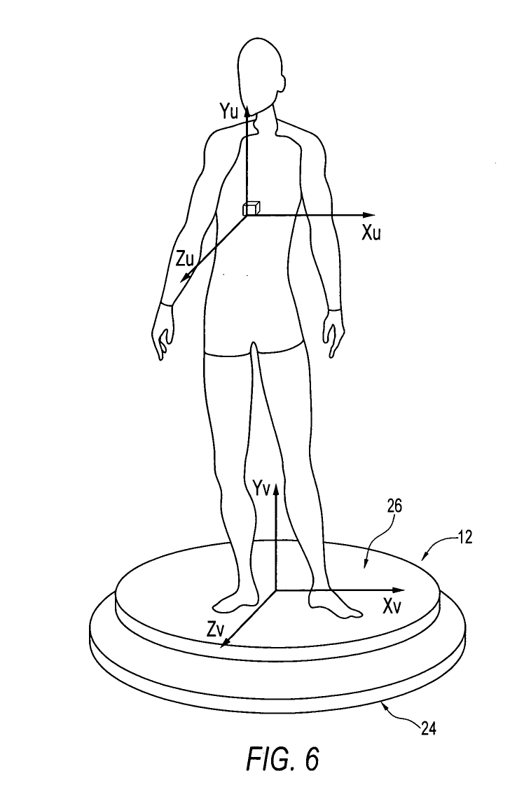

In aligning the VENP system 10 and user 22 coordinate axes, the computational method provides that the coordinate axes of the user are the same as coordinate axes of the orientation device 16 (Xₒ, Yₒ, Zₒ). Alignment of the coordinate axes of the VENP system 10 and user 22 ensures that the angular displacement of the user about a vertical axis (the common Y-axis) can be measured with reference to the VENP coordinate axes. FIG. 6 shows the coordinate axes of the user 22 (Xu-Yu-Zu) and the coordinate axes of the VENP system 10 (Xv-Yv-Zv), respectively.

When detecting the user's 22 orientation, orientation is defined as θ, where θ is the angle about the vertical axis. The orientation is detected/acquired by the orientation device 16 and transferred to the PC 18 or other processor. While the invention is shown and described with a PC 18, it should be understood by one skilled in the art that alternative processors may be used interchangeably, such as, for example, both dedicated and shared PCs, dedicated and shared gaming consoles, as well as handheld devices, to name a few. The orientation data (θ) changes as the user 22 starts to navigate in the virtual world.

To determine the navigation intention, which in the preferred embodiment encompasses determining whether the use 22 intends to go forward or backward, the determination/prediction is made using the preferred algorithm as follows. First, a “master sensor” 34c (best shown in FIG. 3) is designated according to the user's 22 orientation data (θ). The “master sensor” 34c is the one of the sensors 34a, 34b, 34c determined to be located with a particular angular range related to the user's 22 orientation. The left side limit (“LSL”) of the range is calculated as [θ−(180°/number of state sensors)] and the right side limit (“RSL”) of the range is calculated as [θ+(180°/Number of State Sensors)]. The sensor 34a, 34b, or 34c located within the range [LSL<β<RSL] is designated as the master sensor 34c, where β is the angular location of the sensor determined to be the master sensor.

Next, after designating the master sensor 34c, designations are made as to the “front” and “rear” halves of the platform assembly 12. Where, as in the preferred embodiment, the base 24 and impact platform 26 are generally circular, “front” and “rear” portions of the sensing surface 30 are configured to be, respectively, a “front semicircle” 46 and a “rear semicircle” 48 of the platform assembly 12. The front semicircle 46 includes the master sensor 34c as well as one half of the remaining sensors, which in the preferred embodiment is two sensors 34b. The rear semicircle 48 includes the remaining one-half of the sensors, which in the preferred embodiment is two sensors 34a.

More particularly, as illustrated in FIG. 3, once the master sensor 34c is determined, the front and rear semicircles 46, 48 are demarcated by a diameter 50 that extends in a direction perpendicular to a diameter 51 extending from the master sensor and that also generally bisects the base 24 and the circumference formed by the sensors 34a, 34b, 34c. Put another way, the master sensor 54c in the first semicircle 46 is always configured to be at 90° with respect to the diameter 50, while the other two sensors 34b within the front semicircle are configured to be 18° with respect to the diameter. The sensors 34a disposed within the rear semicircle 48 are at 54° with respect to the diameter 50.

Next, the algorithm provides for prediction of a user's 22 navigation intention. A sensor 34a, 34b, 34c is activated and acquires a “high” state when a load, such as the weight of the user 22, is applied to the particular sensor. In contrast, a sensor 34a, 34b, 34c is inactive or at a “low” state, when no load is applied to the sensor. Also, the sensor 34a, 34b, 34c returns to the “low” state when the load is removed. The changes in the state of the sensors 34a, 34b, 34c determine a user's 22 navigation intention (to go forward or backward): if the state of any sensor 34a in the front semicircle 46 goes from “low” to “high,” then the user intends to go forward, whereas if the state of any sensor 34b in the rear semicircle 48 goes from “low” to “high” then the user intends to go backward.

In one of the preferred embodiments illustrated in FIGS. 8 and 9, five contact-type sensors 34a, 34b, 34c are employed. The sensor located in the range: (θ−36°)<β≦(θ+36°) is designated as the master sensor 34c, where β is the angular location of the sensor.

To detect the number of impacts made by the user 22, the preferred algorithm provides for counting the number of impacts. For purposes of illustration, the impacts will be described as a user's 22 steps. The number of steps is equal to the number of times the sensors 34a, 34b, 34c (in the semicircle that the user is stepping in) change from “low”to “high.”

The second, third and fourth steps (orientation detection, predicting navigation intention, and detecting number of impacts) are repeated at the graphics update rate for the entire duration of a user's 22 navigation in the virtual environment. The user's 22 orientation data, the number of steps taken, and the prediction of the user's navigation intention, are provided as input to a virtual reality engine. Based on the input, the virtual reality engine makes the virtual position and orientation changes in the virtual world display, which are visible to the user in real-time via the display device 20. The virtual position change can be computed by multiplying the number of steps with a pre-defined distance representing the distance per step.

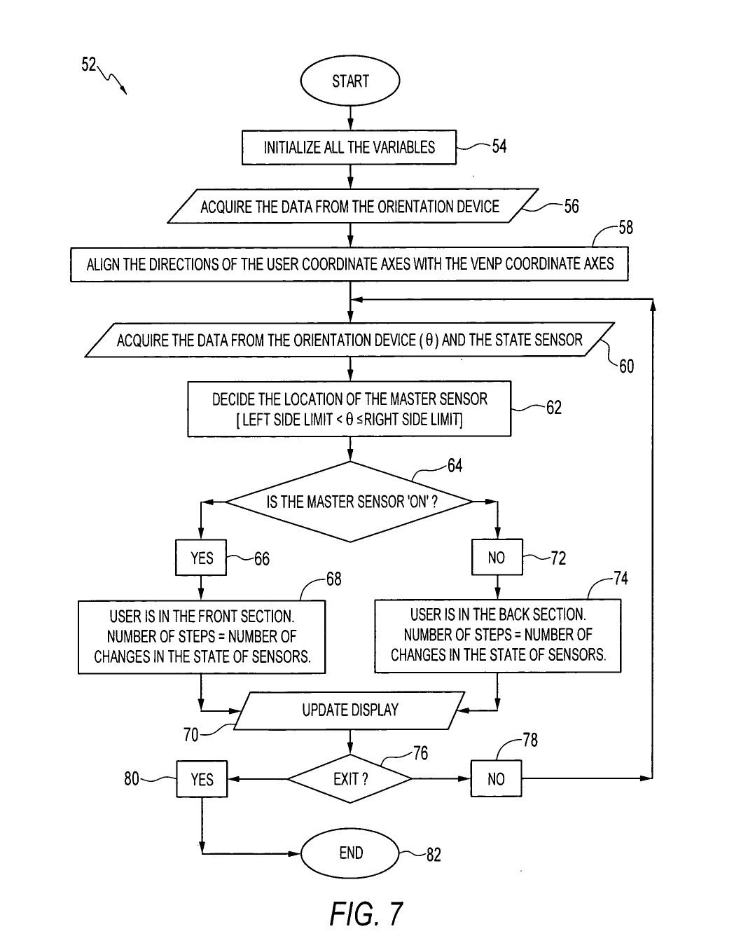

The aforementioned computational method is implemented using a software program. FIG. 7 illustrates a flow chart according to one preferred embodiment of the software subsystem, designated generally at 52.

The variables used in the software implementation to store data are defined as follows. The Data Collection Variables include the integer-type variables (HardwareCounter and SoftwareCounter) and floating-point type variables (OrientationValue). If the number of sensors 34a, 34b, 34c is “N,” then the variables HardwareCounter1 through HardwareCounterN (i.e., HardwareCounter 1, HardwareCounter2, . . . ,HardwareCounterN) count and store the number of times the state of the respective sensor goes from “low” to “high.” The variables SoftwareCounter1 through SoftwareCounterN (i.e., SoftwareCounter1, SoftwareCounter2 . . . ,SoftwareCounterN) store the updated data from the corresponding HardwareCounter variables at the graphics refresh rate. Comparison of the values in the HardwareCounter and SoftwareCounter variables is useful to find if a sensor has gone from “low” to “high.”

The variables OrientationValueX, OrientationValueY and OrientationValueZ store the orientation data received from the orientation device 16. The orientation data contains pitch, yaw and roll angles, which represent the rotational angles about the X, Y, and Z axes, respectively.

The Data Analysis Variables include MasterSensor, FrontLeft, FrontRight, RearLeft and RearRight. After the master sensor 34c is determined by the preferred computational program, the variables MasterSensor, FrontLeft, FrontRight, RearLeft and RearRight are updated with the difference between the values of the HardwareCounter and the SoftwareCounter variables. The integer-type variables NavIntention and NumberSteps are Data Output Variables. The NavIntention variable stores the user's 22 navigation intention (to go forward or backward) and the NumberSteps variable stores the number of steps taken.

The flow chart illustrated in FIG. 7 is illustrative of the computation method of the software subsystem 52. First, in the boxes 54, 56, 58, after the direction of the user's 22 coordinate axes (Xu-Yu-Zu) and the VENP system 10 coordinate axes (Xv-Yv-Zv) have been aligned, the following method is preferably used to implement the computation method. All variables are initialized to zero.

Next, in box 60, data is acquired from the orientation device 16 (θ) and the sensors 34a, 34b, 34c. The OrientationValue variables are updated with the data received from the orientation device 16 and the HardwareCounter variables are updated with data received from the sensors 34a, 34b, 34c and the HardwareCounter variables count and store the number of times the state of the corresponding sensor 34a, 34b, 34c goes from “low” to “high.”

In box 62, the ‘Master Sensor’ is determined as follows. The limiting values of the Master Sensor range are first determined using the OrientationValueY variable data (Yaw angle). The OrientationValueY data (θ) gives the angular displacement of the user about the vertical axis (Yu) with reference to the VENP system 10 coordinate axes (Xv-Yv-Zv). The Left Side Limit of this range is calculated as [θ−(180°/Number of State Sensors)] and the Right Side Limit of this range is calculated as [θ+(180°/Number of State Sensors)]. The State Sensor located in the range [Left Side Limit<β<Right Side Limit] is designated as the 34c, where β is the angular location of the sensor. The master sensor 34c and its adjacent sensors are in the front semicircle 46 while the remaining sensors are in the rear semicircle 48.

Boxes 64, 66, 68, 70, 72, 74 ask and answer the inquiry as to whether the master sensor 34c is on, and how the virtual reality display 20 should be updated, if at all.

The MasterSensor, FrontLeft, FrontRight, RearLeft and RearRight variables are updated with values equal to the differences between the corresponding HardwareCounter and SoftwareCounter variables.

If the value of any of the MasterSensor, FrontLeft or FrontRight variables is a positive integer then the user intends to go forward. The value of the NavIntention variable is set to 1. The number of foot-steps is equal to the summation of the values of the above three variables. This number is stored in the NumberSteps variable.

If the value of any of the RearLeft or RearRight variables is a positive integer then the user intends to go backward. The value of the NavIntention variable is set to 0. The number of foot-steps is equal to the summation of the values in the above two variables. This number is stored in the NumberSteps variable.

The SoftwareCounter variables are updated with the data received from the HardwareCounter variables at the graphics update rate.

Next, in box 76, the subsystem checks for a signal to exit the loop. If there is no signal to exit then repeat the steps discussed with reference to boxes 56 through 76.

Having described the invention, the following examples are given to illustrate specific applications of the invention including the best mode now known to perform the invention. These specific examples are not intended to limit the scope of the invention described in this application.

### EXAMPLE 1

The VENP system 10 has been integrated with the Half-Life® (manufactured by Sierra Entertainment of Bellevue Wash.) first person shooting video game (virtual reality engine). The VENP system 10 enables the user to navigate forward or backward in the game environment, change direction of movement, and walk or run per the stepping of the user.

### EXAMPLE 2

The VENP system 10 has been integrated with the First Responder Simulation and Training Environment (FiRSTE™) at the University of Missouri-Rolla. FiRSTE™ is a virtual reality system developed for training of first responders. It allows the users to enter a virtual environment and navigate around in the training exercise. The VENP provides the user with the ability to walk and run as well as change direction in the virtual environment.

FIG. 8 illustrates a preferred embodiment of the VENP system 10, and FIG. 9 illustrates an exemplary embodiment of the platform assembly 12, where specific configurations and dimensions are provided for purposes of illustration only.

The platform assembly 12 includes the base 24, which is made of wood, is generally circular in shape and has an approximately 50″ diameter. The impact platform 26 is also made of wood, is generally circular in shape and is approximately 30″ in diameter. The pivot 38 is made of metal, is generally spherical in shape and 2″ in height. Five (5) contact-type sensors 38 are employed and the cushioning member 36 is a pneumatic rubber ring.

The DAQ Interface 14 is a National Instruments Data Acquisition Counter Card.

The orientation device 16 is an Intersense Inertial Orientation Sensor.

The PC 18 is a Dell Personal computer.

The display device 20 used is an i-glasses™ Head Mounted Display from the iO Display Systems Inc.

The software subsystem is implemented using Microsoft VC++, and provided on a CD attached to the application. The information on the CD is hereby incorporated by reference

While various embodiments of the present invention have been shown and described, it should be understood that modifications, substitutions, and alternatives are apparent to one of ordinary skill in the art. Such modifications, substitutions, and alternatives can be made without departing from the spirit and scope of the invention, which should be determined from the appended claims.

Various features of the invention are set forth in the appended claims.

1. An impact platform device for use with a virtual reality interface system that promotes navigation by a user in a virtual environment, said platform device comprising:
a platform being configured to receive impacts from the user;
an odd-numbered plurality of sensors evenly spaced about a circumference and disposed relative said platform such that each of said sensors is configured to detect when the user impacts a portion of said platform.

2. The device of claim 1 further comprising a processor for accepting inputs from said plurality of sensors, said processor being programmed to designate a master sensor plus an even number of remaining sensors, where said master sensor and one-half of said even number of remaining sensors are disposed within a first semicircle of said generally circular circumference and one-half of said even number of remaining sensors are disposed within a second semicircle of said generally circular circumference.

3. The device of claim 2 wherein said processor further designates said master sensor to be configured and arranged to be at a 90° angle with respect to said diameter.

4. The device of claim 1 wherein said odd-numbered plurality of sensors comprises five sensors.

5. The device of claim 1 wherein said sensors comprise one of contact sensors, pressure sensors, strain gauges, force sensors, and optical sensors.

6. The device of claim 1 further comprising a base on which said plurality of sensors is disposed.

7. The device of claim 6 further comprising a support for supporting said platform relative said base and permitting relative movement between said base and said platform.

8. The device of claim 7 wherein said support comprises a pivoting member having a generally planar base portion configured to abut an underside of said platform, and a point configured to abut a top surface of said base.

9. A virtual reality interface system that promotes navigation by a user in a virtual environment, said system comprising:
said device of claim 1;
an orientation detector configured to be coupled to the user's body;
a processor for receiving, storing and analyzing data from said sensors and said orientation detector; and
a virtual reality display for displaying a virtual reality environment to the user.

10. The system of claim 9 further comprising a data acquisition interface for receiving data from said sensors and communicating the data from said sensors to said processor.

11. The system of claim 9 wherein said orientation detector comprises inertial sensor configured to be mounted to the user's torso.

12. The system of claim 9 further comprising a cushion for absorbing shock and vibration and producing spring action to break contact between said sensors and said platform.

13. The system of claim 12 wherein said cushion comprises a pneumatic rubber ring disposed between a central axis of said base and a circumference formed by said sensors.

14. The system of claim 9 wherein said processor comprises one of a dedicated PC, a dedicated gaming console, a shared PC, and a shared gaming console.

15. The system of claim 9 wherein said display comprises one of head mounted displays, CRT monitors, video game consoles, and computer automated virtual environment.

16. A software subsystem for use with the virtual reality navigation interface system of claim 9, said subsystem comprising:
alignment instructions for aligning Xᵥ, Yᵥ and Zᵥ coordinate axes of said system with the user's coordinate axes Xᵤ, Yᵤ, Zᵤ;
orientation instructions for detecting the user's orientation based on data received from said orientation means;
prediction instructions for predicting the user's navigation intention; and
detection instructions for detecting a number of impacts made by the user.

17. A method of determining user movement in a virtual reality interface system that promotes navigation by a user in a virtual environment, where the interface system includes a platform assembly for sensing impacts by a user, an orientation device coupled to the user, a data acquisition interface, a processor, an orientation device and a display device, said method comprising:
obtaining data from an odd number of sensors disposed evenly about a circumference;
designating a master sensor; and
dividing with a diameter an area confined by the circumference into a first semicircle and a second semicircle, where the master sensor is disposed within the first semicircle at an angle of 90 degrees with respect to the diameter and one half of the remaining sensors are disposed within the first semicircle, while another half are disposed in the second semicircle.

18. The method of claim 17 further comprising:
collecting input from the orientation device;
communicating orientation data from the orientation device to the processor;
initiating user impact on the platform assembly;
collecting impact data with the platform assembly;
transferring the impact data to the processor via the data acquisition interface;
analyzing by the processor of the impact data along with the orientation data to detect the orientation of the user and the number of impacts made by the user and predict the user's navigation intention; and
providing the orientation changes of the user and the number of steps to a virtual reality engine for updating the display device.

19. The method of claim 17 wherein said analyzing step further comprises:
aligning said system's coordinate axes with the user's coordinate axes;
detecting the user's orientation;
detecting the number of steps made by the user; and
predicting the user's navigation intention.

20. The method of claim 17 further comprising providing five sensors on the platform assembly for sensing impacts by the user and communicating the impacts to the data acquisition device.

21. The method of claim 17 further comprising coupling the orientation device to the user's body.
